(19) United States
(12) Patent Application Publication
(10) Pub. No.: US 2013/0313079 A1
(43) Pub. Date: Nov. 28, 2013

(54) PRODUCT DELIVERING DEVICE OF VENDING MACHINE

(71) Applicants: Hong Fu Jin Precision Industry (WuHan) Co., Ltd., (US); HON HAI PRECISION INDUSTRY CO., LTD., New Taipei (TW)

(72) Inventors: YUN-LUNG CHEN, New Taipei (TW); CHIN-WEN YEH, New Taipei (TW); YANG XIAO, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/790,747

(22) Filed: Mar. 8, 2013

(30) Foreign Application Priority Data
May 24, 2012 (CN) 201210163780.2

(51) Int. Cl. B65G 33/04

(52) U.S. Cl. CPC B65G 33/04
USPC 198/657

(57) ABSTRACT

A product delivering device in a vending machine includes a delivering member, a delivering member and driving member. The delivering member includes an engaging portion and a coil delivering portion. A locking groove is defined in the driving member extending along an axial direction. The engaging portion is engaged with the locking groove along the axial direction of the driving member, and the driving member is configured to rotate the coil delivering portion.

### BACKGROUND

The disclosure generally relates to a product delivering device for a vending machine.

### Description of Related Art

A vending machine is a machine which dispenses multiple consumer items such as snacks, beverages, alcohol, cigarettes, for example after the customer inserts currency or credit into the machine. A common form of vending machine for providing snacks often uses a metal coil, which is rotated to release the ordered product. The metal coil is connected to a rotating member, which can rotate the rotating member. The traditional metal coil has a connecting end to laterally insert into the rotating member. However, if the metal coil is assembled to or is disassembled from the rotating member, the metal coil may move laterally to interfere with other components. There is a room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a product delivering device in one embodiment.

FIG. 2 is an exploded, isometric view of a fixing assembly, a driving member, and a clasp of FIG. 1.

FIG. 3 is an enlarged view of a circled portion III of FIG. 1.

FIG. 4 is a partial assembly view of the product delivering device of FIG. 1.

FIG. 5 is an assembly view of the product delivering device of FIG. 1.

FIG. 6 is similar to FIG. 5, but a delivering member is rotated to another position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

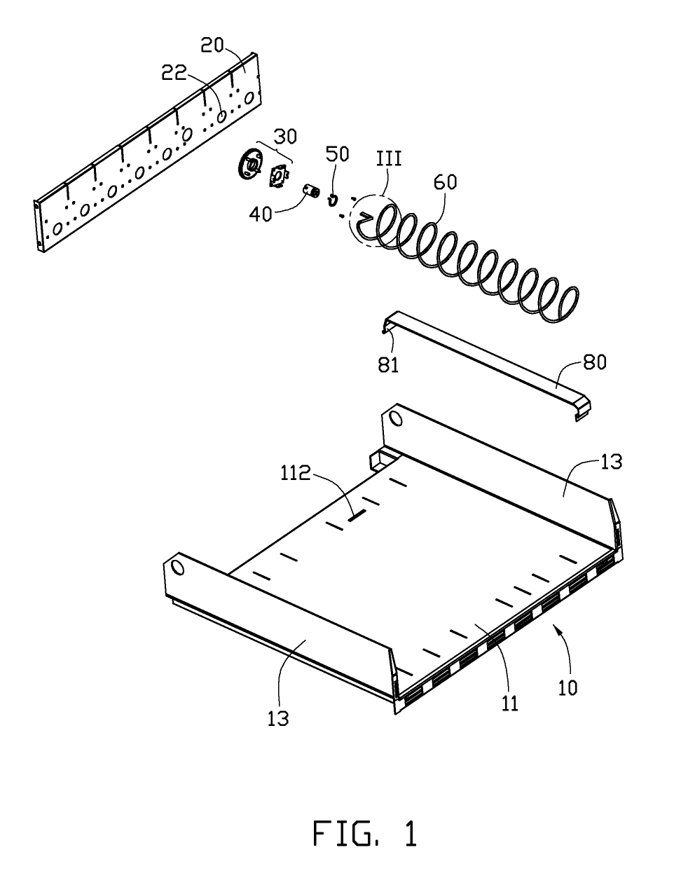

FIG. 1 is one embodiment of a product delivering device used in a vending machine. The product delivering device includes a chassis 10, a rear panel 20, a fixing assembly 30, a driving member 40, a clasp 50, a delivering member 60 and a supporting member 80. The product delivering device can store product on the delivering member 60 and can rotate to release the product by ordering the product.

The chassis 10 includes a bottom wall 11 and two side walls perpendicular to bottom wall 11. A mounting slot 112 is defined in the bottom wall 11. A receiving hole 22 is defined in the rear panel 20 for receiving the fixing assembly 30.

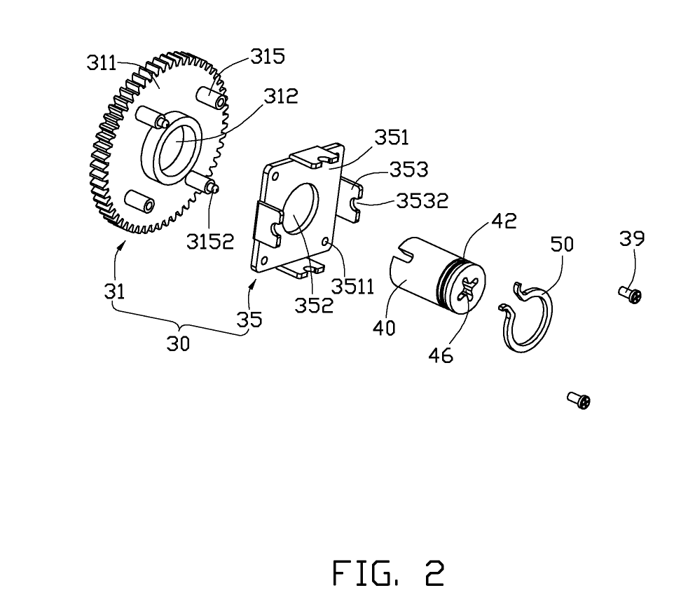

FIG. 2 shows that the fixing assembly 30 includes a gear 31, a locating member 35, and at least one fastener 39 to mount the locating member 35 to the gear 31. The gear 31 includes a wheel 311 and four posts 315 located on the wheel 311. A first through hole 312 is defined in the wheel 311. The wheel 311 has outer teeth. Two of the posts 315 located on diagonal have pins 3152. Other two of the posts 315 define screw holes. The locating member 35 includes a substantially square locating board 351 and four tabs 353 protruding from four side edges of the locating board 351. The four tabs 353 are substantially perpendicular to the locating board 351. A cutout 3532 is defined in each tab 353. The cutout 3532 may be arcuate. A second through hole 352 is defined in the locating board 351 corresponding to the first through hole 312. Four locking holes 3511 are defined in the locating board 351.

The driving member 40 is a cylinder. An annular groove 42 is defined around the driving member 40 for receiving the clasp 50. A locking groove 46 is defined in the driving member 40 extending along an axial direction. A cross section of the locking groove 46 is crossed or straight. The clasp 50 is resilient and is substantially C-shaped.

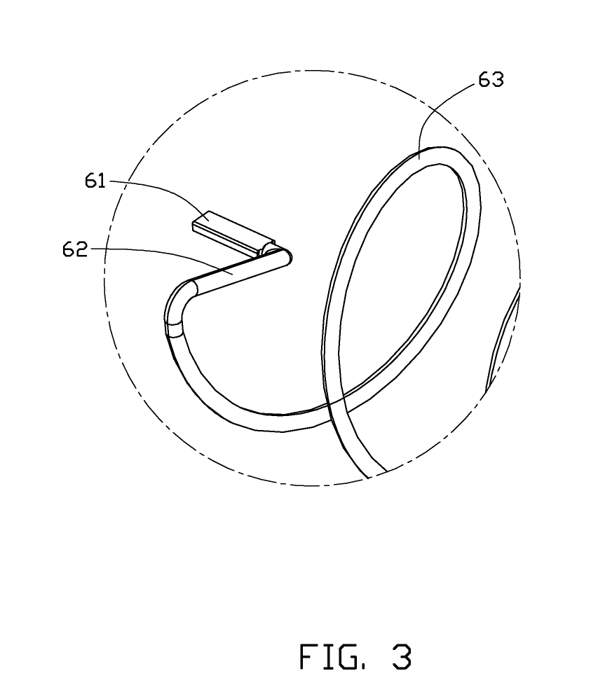

FIG. 3 shows that the delivering member 60 includes an engaging portion 61, a connecting portion 62 connected to the engaging portion 61, and a delivering portion 63. The delivering portion 63 is resilient, coil and can be made of metal. A cross section of the engaging portion 61 is straight corresponding to the locking groove 46. A cross section of the delivering portion 63 is circled.

The supporting member 80 is an elongated sheet. The supporting member 80 includes two bent mounting portions 81.

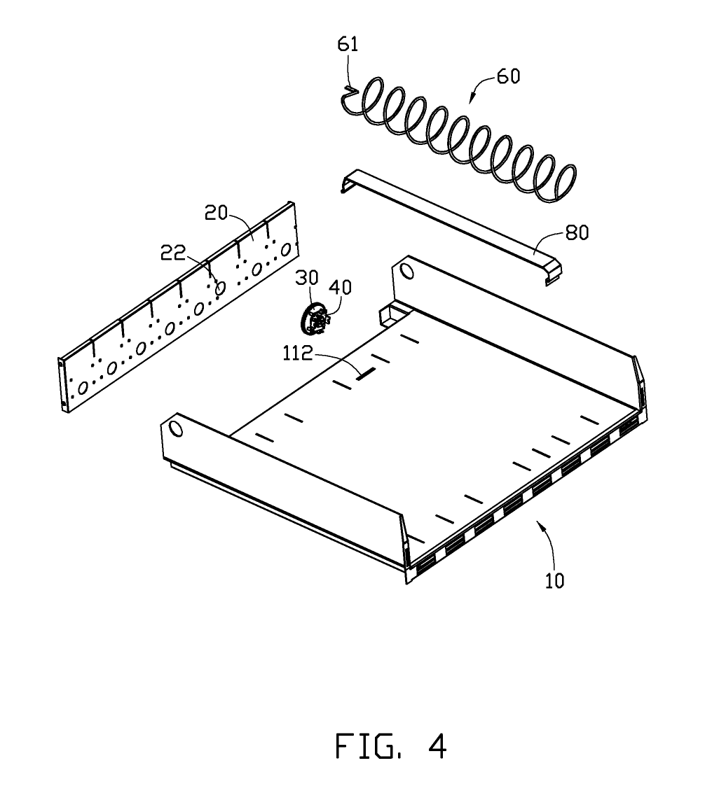

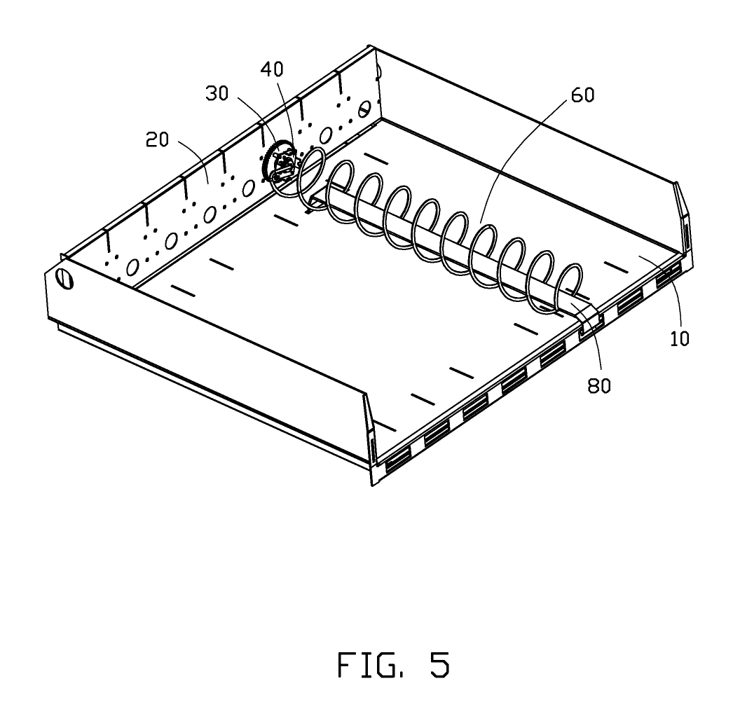

FIG. 4 and FIG. 5 show that in assembly, two ends of the pins 3152 are inserted into the corresponding locking holes 3511 of the locating board 351. The fasteners 39 are screwed into the other two posts 315 through the locking holes 3511. The locating member 35 is fixed to the gear 31. The driving member 40 is inserted into the first through hole 312 and the second through hole 352. The clasp 50 surrounds the driving member 40 and engages into the annular groove 42. The assembled driving member 40 and the fixing assembly 30 are mounted to the rear panel 20. The engaging portion 61 of the delivering member 60 is inserted into the locking groove 46. The connecting portion 62 is buckled to one of the cutouts 3532 of the tabs 353. The supporting member 80 extends through the delivering portion 63 and is mounted to the mounting slot 112 at the mounting portions 81.

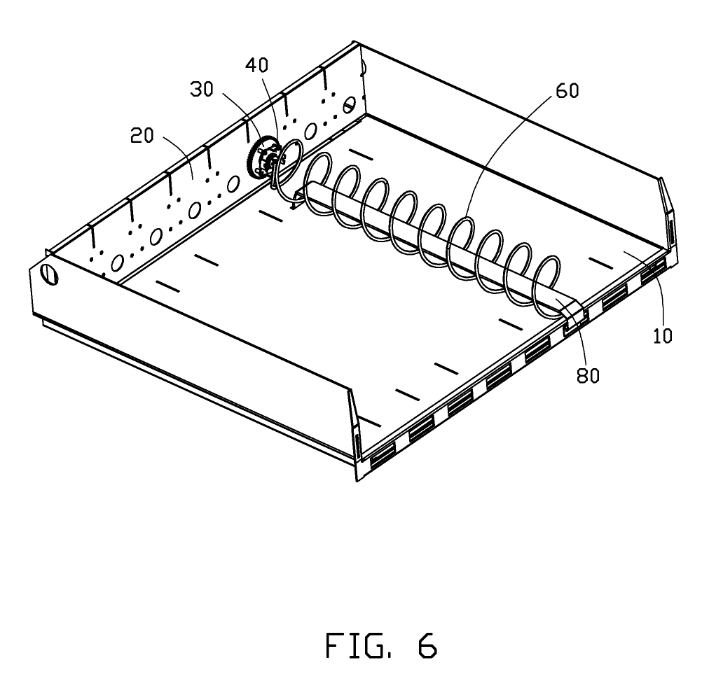

FIG. 6 shows that in use, the products are positioned on the delivering portion 63. The driving member 40 can be driven by a motor to rotate about the axial direction. The delivering member 60 rotates with the driving member 40. The product on the end of the delivering portion 63 is released.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A product delivering device in a vending machine, comprising:
a delivering member comprising an engaging portion and a coil delivering portion; and
a driving member, and a locking groove defined in the driving member extending along an axial direction;
wherein the engaging portion is engaged with the locking groove along the axial direction of the driving member, and the driving member is configured to rotate the coil delivering portion.

2. The product delivering device of claim 1, further comprising a fixing assembly, wherein the driving member extends through the fixing assembly.

3. The product delivering device of claim 2, wherein the driving member comprises a locating member, the locating member comprises at least one tab, and the delivering member is engaged with the at least one tab.

4. The product delivering device of claim 3, wherein the at least one tab comprises four tabs, the four tabs are configured to engage with the delivering member along four different directions.

5. The product delivering device of claim 4, wherein an arcuate cutout is defined in each of the four tabs for receiving the delivering member.

6. The product delivering device of claim 3, wherein the fixing assembly further comprises a gear, the locating member is mounted to the gear, an annular groove is defined in the driving member, a clamp is engaged with the annular groove for preventing the driving member extending through the gear and the locating member.

7. The product delivering device of claim 1, wherein a cross section of the locking groove is crossed.

8. The product delivering device of claim 7, wherein a cross section of the engaging portion of the delivering member is straight.

9. The product delivering device of claim 1, wherein the coil delivering portion comprises metal.

10. The product delivering device of claim 9, further comprising a chassis and a supporting member mounted to the chassis, wherein the supporting member extends through the coil delivering portion.

11. A product delivering device in a vending machine, comprising:
a delivering member comprising an engaging portion and a delivering portion;
a driving member, a locking groove defined in the driving member, an axis extending through the locking groove; and
a fixing assembly configured to attach the driving member;
wherein the engaging portion is inserted into the locking groove along an axial direction of the driving member, and the driving member is configured to rotate the delivering portion relative to the fixing assembly about the axis.

12. The product delivering device of claim 11, wherein the driving member extends through the fixing assembly.

13. The product delivering device of claim 12, wherein the driving member comprises a locating member, the locating member comprises at least one tab, and the delivering member is engaged with the at least one tab.

14. The product delivering device of claim 13, wherein the at least one tab comprises four tabs, the four tabs are configured to engage the delivering member from four different directions.

15. The product delivering device of claim 13, wherein an arcuate cutout is defined in each of the at least one tab for receiving the delivering member.

16. The product delivering device of claim 13, wherein the fixing assembly further comprises a gear, the locating member is mounted to the gear, an annular groove is defined in the driving member, a clamp is engaged with the annular groove for preventing the driving member extending through the gear and the locating member.

17. The product delivering device of claim 11, wherein a cross section of the locking groove is crossed.

18. The product delivering device of claim 17, wherein a cross section of the engaging portion of the delivering member is straight.

19. The product delivering device of claim 11, wherein the delivering portion comprises a metal coil.

20. The product delivering device of claim 19 further comprising a supporting member, wherein the supporting member extends through the delivering portion.
